(19) United States
(12) Patent Application Publication
(10) Pub. No.: US 2023/0309601 A1
(43) Pub. Date: Oct. 5, 2023

(54) 3D PRINTING OF MILK-BASED PRODUCT

(71) Applicant: Singapore University of Technology and Design, Singapore (SG)

(72) Inventors: Michinao HASHIMOTO, Singapore (SG); Cheng Pau LEE, Singapore (SG); Rahul KARYAPPA, Singapore (SG)

(21) Appl. No.: 18/004,460

(22) PCT Filed: Jul. 6, 2021
(86) PCT No.: PCT/SG2021/050391

§ 371 Date: Jan. 6, 2023

(30) Foreign Application Priority Data
Jul. 6, 2020 (SG) 10202006499U

(51) Int. Cl. A23P 20/20; A23C 9/15; A23G 1/00; B33Y 80/00; B33Y 10/00

(52) U.S. Cl. CPC A23P 20/20; A23C 9/1508; A23P 2020/253; B33Y 80/00; B33Y 10/00; A23G 1/0063

(57) ABSTRACT

Herein disclosed includes an edible and 3D printable milk-based ink composition comprising milk powder present in an amount ranging from 10 to 75 w/w %, and water, wherein the edible and 3D printable milk-based ink composition is both printable and remains in a single phase at a temperature ranging from 20° C. to 30° C. A method of 3D printing the edible and 3D printable milk-based ink composition is included herein. The method includes providing the edible and 3D printable milk-based ink, and dispensing the edible and 3D printable milk-based ink composition onto a substrate in the absence of temperature control of the edible and 3D printable milk-based ink composition.

### CROSS-REFERENCE TO RELATED APPLICATION

This application claims the benefit of priority of Singapore Patent Application No. 10202006499U, filed 6 Jul. 2020, the content of it being hereby incorporated by reference in its entirety for all purposes.

### TECHNICAL FIELD

The present disclosure relates to an edible and three-dimensional (3D) printable milk-based ink composition. The present disclosure also relates to a method of 3D printing the edible and 3D printable milk-based ink composition.

### BACKGROUND

3D printing allows layer-by-layer fabrication of 3D structures using materials specific to the mechanism of printing, ranging from thermoplastics and hydrogels. This technology is applied across diverse fields of engineering, including bio-printing to create new organs, metal printing to create aeroplane parts, concrete printing to construct houses and materials printing to create electronic devices and microfluidic devices. Food printing is one of the emerging applications. Different methods of 3D printing have been demonstrated for food, which traditionally includes selective laser sintering (SLS) in which a laser is used to melt and fuse powder particles.

In SLS, the printable materials tend to be limited to those based on sugars and fats to ensure thermal fusion by laser sintering.

Alternatively, extrusion-based methods have been widely used in food printing because of their flexibility to dispense liquid-based food materials. Hot-melt extrusion may have been traditionally the most widely-used method of extrusion-based food.

Methods such as hot-melt extrusion and SLS are likely not always suitable to model temperature-sensitive food, as such methods tend to require elevated temperature to melt food samples. For example, milk is rich in nutrients such as calcium and protein that tend to be temperature sensitive, and not compatible with processes involving high temperature.

Another alternative, cold extrusion, requires the additional use of food additives to alter the rheological properties of the food ink. In cold extrusion, 3D printing relies solely on the rheology of ink, wherein additives tend to be commonly included in food ink to alter the rheological properties for cold extrusion. In one reported example, xanthan gum and K-carrageenan gum were added into mashed potatoes to print self-supporting structures. In another reported example, glycerol, xantham gum, and whey protein were used to facilitate printing. These reported methods involved the use of additives to maintain the fidelity of the printed structures. As such, there is increasing interest to 3D-print temperature sensitive food materials via cold extrusion. Currently available food inks for cold extrusion contain multiple additives with pre-identified concentrations, which entails complexity that requires judicious optimization to achieve the printability.

There is thus a need to provide for a solution that addresses one or more of the limitations mentioned above. The solution should at least address the challenges to 3D-print temperature sensitive food.

### SUMMARY

In a first aspect, there is provided an edible and 3D printable milk-based ink composition that includes:
milk powder present in an amount ranging from 10 to 75 w/w %; and
water,
wherein the edible and 3D printable milk-based ink composition is both printable and remains in a single phase at a temperature ranging from 20° C. to 30° C.

In another aspect, there is provided a method of 3D printing the edible and 3D printable milk-based ink composition described in various embodiments of the first aspect, the method includes:
providing the edible and 3D printable milk-based ink composition described in various embodiments of the first aspect; and
dispensing the edible and 3D printable milk-based ink composition onto a substrate in the absence of temperature control of the edible and 3D printable milk-based ink composition.

Various aspects and embodiments disclosed herein demonstrate for cold extrusion of the present ink composition, which is a food ink, via improvement of rheological properties without the need for additives.

Various aspects and embodiments disclosed herein are demonstrated using a milk product as a non-limiting example. The present ink composition formulated is based on a milk-based ingredient configured with desirable rheological properties. As described in the present disclosure, demonstration of 3D printing of milk without additional rheological modifiers at room temperature (20° C. to 30° C.) has been successful. The rheological properties of the present milk ink may involve modification of the concentration of milk powder in the present ink composition, which was characterized and evaluated for printability, including 3D printability.

Various aspects and embodiments disclosed herein include inks containing 70 to 75 w/w % of milk powders, which may successfully print complex 3D structures.

Extending the demonstration, multi-material printing with milk ink and other edible inks were successful. The principles and methods disclosed here are applicable to other edible inks for the DIW 3D printing at room temperature, which are applicable to a wide range of applications in the customized fabrication of food products by 3D printing. The present disclosure demonstrates a straightforward method having rheology of food inks configured for printability. This capability contributes to unlocking full potential of 3D printing of foods that aids configuration of texture, and preservation and personalization of nutrition.

### BRIEF DESCRIPTION OF THE DRAWINGS

The drawings are not necessarily to scale, emphasis instead generally being placed upon illustrating the principles of the present disclosure. In the following description, various embodiments of the present disclosure are described with reference to the following drawings, in which:

FIG. 1A is a photograph depicting a setup for direct ink writing (DIW) 3D printing for cold extrusion according to various embodiments of the present disclosure. Specifically, FIG. 1A is a photograph of the DIW printer used in the experiment.

FIG. 1B is a schematic illustration of DIW of mesh structure with milk ink onto a glass substrate.

FIG. 2A demonstrates for rheological characterization of milk inks of the present disclosure (10-75 w/w %; 10 w/w % was denoted as M10, etc.). Specifically, FIG. 2A is a plot of viscosity (μ) as a function of applied shear rate (γ).

FIG. 2B demonstrates for rheological characterization of milk inks of the present disclosure (10-75 w/w %; 10 w/w % was denoted as M10, etc.). Specifically,

FIG. 2B is a plot of storage moduli (G′) and loss moduli (G″) as a function of applied oscillatory shear stress (σ).

FIG. 2C demonstrates for rheological characterization of milk inks of the present disclosure (10-75 w/w %; 10 w/w % was denoted as M10, etc.). Specifically, FIG. 2C is a plot of thixotropic loop test measuring the shear stress (σ) as a function of increasing (solid symbols) and decreasing (open symbols) shear rates (γ).

FIG. 2D demonstrates for rheological characterization of milk inks of the present disclosure (10-75 w/w %; 10 w/w % was denoted as M10, etc.). Specifically, FIG. 2D is a plot of stress ramp test for ink M60 to determine its yield stress at 25° C.

FIG. 3 shows optical images of the DIW 3D-printed models of milk via the method of the present disclosure. The effects of the concentration of milk on the spreading of the printed ink were evident from the printed models. The mesh structures printed with inks of M10, M60, and M65 spread and filled the gaps. The printed mesh structures were maintained after printing with M70 and M75. All scale bars denote 5 mm.

FIG. 4A shows optical images of the 3D printed complex structures via the method of the present disclosure. Specifically, FIG. 4A shows front, side, back, and isometric views of the 3D models and printed structures with inks of M60, M70, and M75. Scale bar denotes for 5 mm.

FIG. 4B shows an optical image of the 3D printed complex structures via the method of the present disclosure. Specifically, FIG. 4B shows a printed structure of a fortress printed from the ink of M70. Scale bar denotes for 5 mm.

FIG. 4C shows an optical image of the 3D printed complex structures via the method of the present disclosure. Specifically, FIG. 4C shows a printed structure of a wheel printed from the ink of M70. Scale bar denotes for 5 mm.

FIG. 4D shows an optical image of the 3D printed complex structures via the method of the present disclosure. Specifically, FIG. 4D shows a printed structure of a clover leaf printed from the ink of M70. Scale bar denotes for 5 mm.

FIG. 5A demonstrates for 3D-printed multi-food models via method of the present disclosure. FIG. 5A is a schematic illustration of multi-material DIW 3D printing. Leftmost to rightmost images depicts for steps 1 to 3, respectively.

FIG. 5B demonstrates for 3D-printed multi-food models via method of the present disclosure. FIG. 5B shows a 3D structure of a couch printed with milk and chocolate inks at different layers. Scale bar denotes 5 mm.

FIG. 5C demonstrates for 3D-printed multi-food models via method of the present disclosure. FIG. 5C shows a 3D printed cone containing liquid chocolate syrup as an internal filling. Scale bar denotes 5 mm.

FIG. 5D demonstrates for 3D-printed multi-food models via method of the present disclosure. FIG. 5D shows a 3D printed cube with four compartments containing liquid blueberry syrup, liquid chocolate syrup, milk cream, maple syrup as internal fillings. Scale bar denotes 5 mm.

FIG. 6 depicts a table that tabulates yield stress and parameters of Herschel-Buckley model of milk inks with different concentrations presently formulated. All values were calculated as means (±standard deviations).

FIG. 7 depicts a table that tabulates oscillatory amplitude sweep test results tested at 25° C. All values were calculated as means (±standard deviations).

FIG. 8 depicts a table that tabulates thixotropic parameters for the milk inks with different concentrations tested at 25° C. All values were calculated as means (±standard deviations).

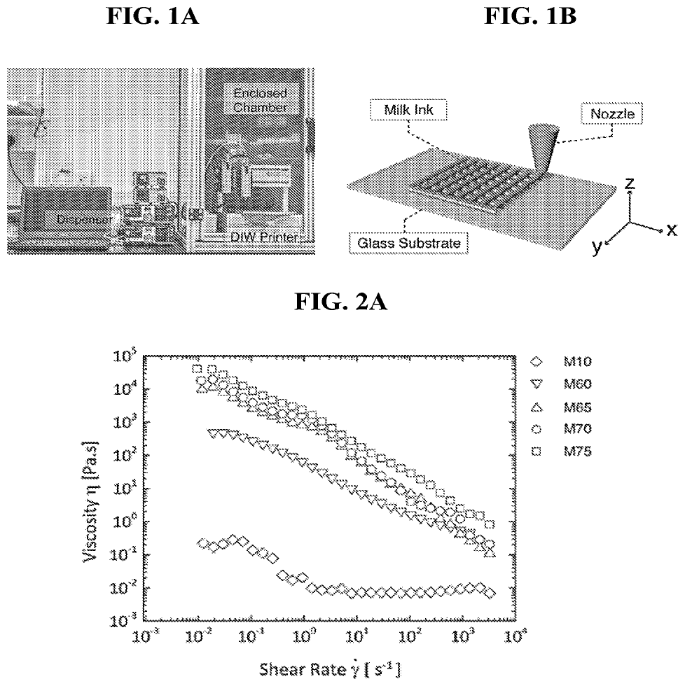

### DETAILED DESCRIPTION

The following detailed description refers to the accompanying drawings that show, by way of illustration, specific details and embodiments in which the present disclosure may be practised.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present disclosure relates to an edible and three-dimensional (3D) printable milk-based ink composition, and a method of 3D printing the edible and 3D printable milk-based ink composition. For brevity, the edible and three-dimensional (3D) printable milk-based ink composition may be referred to herein as “ink composition”, “milk-based ink” and “milk ink”. The present method may be described as a method to perform direct ink writing (DIW) 3D printing of milk-based products at room temperature wherein the rheological properties of the present ink composition is configured.

Traditionally, 3D printing of food tends to been achieved methods such as selective laser sintering (SLS) and hot-melt extrusion. These methods may not always be compatible with temperature sensitive nutrients. Milk is an example of such foods rich in nutrients such as calcium and protein that is deemed temperature sensitive. Cold-extrusion is an alternative method of 3D printing, but it requires the addition of rheology modifiers and the optimization of the multiple components. Currently, there are few methods available for 3D printing of milk. The present ink composition and method address the above limitations. The present ink composition and method successfully demonstrate for DIW 3D printing of milk by cold-extrusion with a formulated milk ink. The present ink composition and method involve specifically one milk product (powder milk). The present ink composition and method involve configuration of the concentration of milk powder that confers a facile formulation of 3D printable milk inks. Extensive characterization of the present formulated milk ink for their rheological properties was carried out to demonstrate printability. The present ink composition and method have potential applications in formulating various nutritious foods (including those served in hospital foods for special needs), where food ink can be extruded at room temperature to create aesthetically pleasing and healthy meals customized for the needs of patients. In other words, the present ink composition and method have potential applications in formulating foods with various needs for nutrition and materials properties, where food inks can be 3D printed at room temperature without compromising the nutrients that would be degraded at elevated temperatures. Each food material contains different constituents of fats, starch, protein, etc. and these contribute to different rheological properties, especially when water or a solvent is added. As such, a chocolate-based ink formulated from chocolate powder and chocolate syrup has different rheological properties from each of its components and other types of food material. Therefore, as a non-limiting example, the modification of rheological properties of such a chocolate-based ink involves such a consideration. Comparatively, the present milk-based ink composition involves components, e.g. a milk powder and water, which are distinct from those in the chocolate-based ink and other food inks, and hence involves a different modification of the milk-based ink composition's rheological properties. In addition, the desired rheological properties are traditionally achieved by using additives (e.g. hydrocolloids), but the present milk-based ink composition circumvents use of such additives.

Details of various embodiments of the present ink composition and method and advantages associated with the various embodiments are now described below.

In the present disclosure, there is provided an edible and 3D printable milk-based ink composition, wherein the edible and 3D printable milk-based ink composition can be both printable and remains in a single phase (e.g. without completely solidifying from a liquid during printing) at a temperature ranging from 20° C. to 30° C., 25° C. to 30° C., 20° C. to 25° C., etc.

The edible and 3D printable milk-based ink composition may include milk powder and water. The milk powder may be present in an amount ranging from 10 to 75 w/w %, 10 to 60 w/w %, 10 to 65 w/w %, 60 to 65 w/w %, 60 to 75 w/w %, 65 to 75 w/w %, 70 to 75 w/w %, etc. Such concentrations render the present ink composition printable via cold-extrusion and circumvents the need for temperature control at room temperature.

In certain non-limiting embodiments, the milk powder may be present in an amount ranging from 10 to 60 w/w %. Such concentrations are advantageous for printing undefined (e.g. irregular) layers and structures, for example, a flat base that has no regular shape. In certain non-limiting embodiments, the milk powder may be present in an amount ranging from 65 to 75 w/w %. In certain non-limiting embodiments, the milk powder may be present in an amount ranging from 70 to 75 w/w %. Such concentrations are advantageous for printing 3D layers and structures.

In various embodiments, the edible and 3D printable milk-based ink composition may be a thixotropic fluid. The term “thixotropic fluid” herein refers to a fluid which can take a certain amount of time to attain equilibrium viscosity when introduced to a steep change in shear rate. In other words, thixotropic fluids may remain thick or viscous under static conditions but flows (e.g. become thinner, less viscous) over time when shaken, agitated, stressed (e.g. shear-stressed).

In various embodiments, the edible and 3D printable milk-based ink composition may have a flow consistency index ranging from more than 0.01 Pa sⁿ to 3450 Pa sⁿ, 0.01 Pa sⁿ to 39 Pa sⁿ, 360 Pa sⁿ to 3450 Pa sⁿ, 825 Pa sⁿ to 3450 Pa sⁿ, etc., wherein n denotes a shear-thinning index ranging from more than 0 to less than 1.

In various embodiments, edible and 3D printable milk-based ink composition may have a yield stress ranging from 0.01 Pa to 360 Pa, 0.01 Pa to 13.5 Pa, 72 Pa to 360 Pa, 92 Pa to 360 Pa, etc.

In various embodiments, the edible and 3D printable milk-based ink composition may have a storage modulus ranging from 82 Pa to 60 kPa, 82 Pa to 295 Pa, 6.78 kPa to 60 kPa, 15.9 kPa to 60 kPa, etc.

The edible and 3D printable milk-based ink composition of the present disclosure can be printed with other edible food inks, either together or separately. In separate printing, the edible and 3D printable milk-based ink composition may be printed to form a structure first. Then, other edible food inks may be printed onto the milk-based structure that was printed to complete part of or the entire structure. In various embodiments, the edible and 3D printable milk-based ink composition may include an edible food ink. The editable food ink may include chocolate, coconut, maple syrup, blueberry, and/or milk cream. The chocolate may include (i) a chocolate syrup, a chocolate paste, or a combination thereof, and (ii) cocoa powder present in an amount ranging from 5 to 25 w/w %, 10 to 25 w/w %, 12 to 25 w/w %, 15 to 25 w/w %, 20 to 25 w/w %, etc. Such amounts help to render the edible and 3D printable ink composition possible for extrusion through a syringe or nozzle without compromising print fidelity of the resultant 3D structure. The term “fidelity” herein refers to the accuracy of the printed 3D structure based on the inputs provided to a software that modulates/operates how the chocolate may be dispensed to afford a printed 3D structure.

Advantageously, the edible and 3D printable milk-based ink composition can be absent of additive to be printable. Additives that can be circumvented includes, but are not limited to, xanthan gum, K-carrageenan gum, etc.

The present disclosure also includes a method of 3D printing the edible and 3D printable milk-based ink composition described in various embodiments of the first aspect. The method includes providing the edible and 3D printable milk-based ink composition described in various embodiments of the first aspect, and dispensing the edible and 3D printable milk-based ink composition onto a substrate in the absence of temperature control of the edible and 3D printable milk-based ink composition.

Embodiments and advantages described for the edible and 3D printable milk-based ink composition described in various embodiments of the first aspect can be analogously valid for the present method subsequently described herein, and vice versa. As the various embodiments and advantages have already been described above and examples demonstrated herein, they shall not be iterated for brevity.

In various embodiments, providing the edible and 3D printable milk-based ink composition may include filling one or more syringes with the edible and 3D printable milk-based ink composition. In various embodiments, each of the one or more syringes may be configured with a nozzle.

In various embodiments, dispensing the edible and 3D printable milk-based ink composition may include positioning the nozzle at a distance from the edible and 3D printable milk-based ink composition which has deposited on the substrate, wherein the distance ranges from 200 μm to 500 μm, 300 μm to 500 μm, 400 μm to 500 μm, 200 μm to 300 μm, 200 μm to 400 μm, 300 μm to 400 μm, etc. Advantageously, the standoff distance is adjustable based on the viscosity of the inks. For example, the various samples demonstrated in the present disclosure using present milk inks with the lower viscosity had a lower thickness compared to inks with higher viscosity, hence required a lower standoff distance.

In various embodiments, dispensing the edible and 3D printable milk-based ink composition may include dispensing the edible and 3D printable milk-based ink composition at a temperature ranging from 20° C. to 30° C., 25° C. to 30° C., 20° C. to 25° C., etc.

In various embodiments, dispensing the edible and 3D printable milk-based ink composition may include applying a pressure ranging from 100 to 550 kPa to dispense the edible and 3D printable milk-based ink composition.

In various embodiments, the present method may further include providing an edible food ink, and dispensing the edible food ink for 3D printing with the edible and 3D printable milk-based ink composition. The editable food ink may include chocolate, coconut, maple syrup, blueberry, and/or milk cream. Advantageously, the present method is capable of printing a food product from multiple food inks, including the present milk-based ink composition. Also, such multi-material printing capability is demonstrated in one of the examples described in the example section below. Further advantageously, other edible inks possessing similar rheological properties as the milk ink formulated are suitable for use with the present method.

The word “substantially” does not exclude “completely” e.g. a composition which is “substantially free” from Y may be completely free from Y. Where necessary, the word “substantially” may be omitted from the definition of the present disclosure.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance. The variance may be ±20%, ±10%, ±5%, ±1%, ±0.5%, ±0.1%, etc.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

### EXAMPLES

The present disclosure relates to a method of performing direct ink writing (DIW) three-dimensional (3D) printing of milk products at room temperature by working on the rheological properties of the printing ink. Traditionally, 3D printing methods such as hot-melt extrusion and selective laser sintering are not always suitable to model temperature-sensitive food, as they require the elevated temperature to melt food samples. To overcome the challenges to 3D-print temperature sensitive food, the present disclosure demonstrated cold extrusion of food inks by improving rheological properties without extensive use of additives. The examples herein include demonstration using a milk product. The formulated milk ink is based on a single milk-based ingredient that controls the rheological properties of its own ink. 3D-printed structures with inks containing 70-75 w/w % of milk powders were successfully fabricated.

The present ink composition and method are described in further details, by way of non-limiting examples, as set forth below.

### Example 1: Preparation of Milk Ink

Materials used were commercially available milk powder (Fernleaf Family Milk, Fonterra, Malaysia) and deionized (DI) water. The samples of the milk ink were prepared by adding milk powder into deionized water at different weight concentrations (M10, M60, M65, M70, and M75; e.g. 10 w/w % is denoted as M10, etc.). The chocolate ink used in multi-food printing was formulated by mixing 20 w/w % of cocoa powder (Hershey's Cocoa, Hershey, USA) with chocolate syrup (Hershey's Syrup, Hershey, USA). Samples were then mixed thoroughly and degassed with Thinky Mixer (ARE-250, Thinky Corporation, Tokyo, Japan) at 25° C. Other materials used in multi-material printing included maple syrup (Great Northern Pure Organic Maple Syrup, Foodsterr, Canada), blueberry syrup (Great Northern Organic Blueberry Maple Syrup, Foodsterr, Canada) and milk cream (Fresh Cream, Amul, India), all of which were used as purchased.

### Example 2: Rheological Characterization

The rheology measurement of the ink was performed with an oscillatory rheometer (Discovery Hybrid Rheometer DHR-2, TA Instruments, Delaware, USA). Parallel plates consisting of stainless steel with a diameter of 40 mm and a truncation gap of 1000 mm were used for all measurements. Viscosity tests were conducted by applying a stepwise shear rate ramp from 0.1 to 2000 s⁻¹. The stress sweep measurements were conducted with a logarithmically increasing shear stress at a constant frequency of 1 Hz over the range of 0.1 to 4000 Pa to determine the viscoelastic properties of the samples. Thixotropy loop tests were conducted with a logarithmically increasing shear rate over the range of 0.0001 to 10 s⁻¹ and then returned with a logarithmically decreasing shear rate to the initial shear rate. Prior to the test, all excess material outside the plate was removed to prevent the edge effects. All rheological measurements were conducted at 25±0.1° C. on triplicate samples.

### Example 3: Direct Ink Writing (3D Printing)

3D printing was performed using a pneumatic DIW printer (SHOTmini 200 Sx, Musashi Engineering, Inc., Tokyo Japan). MuCAD V (Musashi Engineering, Inc., Tokyo, Japan) software was used in conjunction with the DIW printer to control the toolpath and speed of the nozzle. The DIW printer was enclosed in a chamber to maintain a sterile environment. 3D models were obtained from Thingiverse, a public repository of 3D printable models, or designed on Solidworks (Dassault Systèmes, Waltham, MA, USA). 3D model designed on Solidworks was then converted to stereolithography (STL) file format in the software itself, while the 3D model obtained from Thingiverse was downloaded in the STL format. The STL model was imported to Slic3r, an open-source software that slices model, into 200-500 mm thick layers. The software generated G-code for 3D printing. G-code was converted to MuCAD V code via a script written in Python and loaded to the DIW printer. All samples were loaded into a 50 mL luer-lock dispensing barrel fitted with the nozzles of the fixed diameters (22-27 G, Birmingham Gauge). The barrel was then placed onto the syringe holder on the DIW printer. The substrates in the examples can be glass substrates. Prior to printing, the standoff distance between the substrate and nozzle was calibrated to the layer thickness, 200-500 mm, depending on the viscosity of the milk ink. A height feeler gauge was used to control the standoff distance accurately. The printer was programmed manually to lower the nozzle until the tip touched the height feeler gauge. The printing speed and dispensing pressure were also calibrated according to the viscosity of the milk ink. All printings were performed at room temperature.

### Example 4A: Results/Discussion—Rheological Characterization of Milk Ink

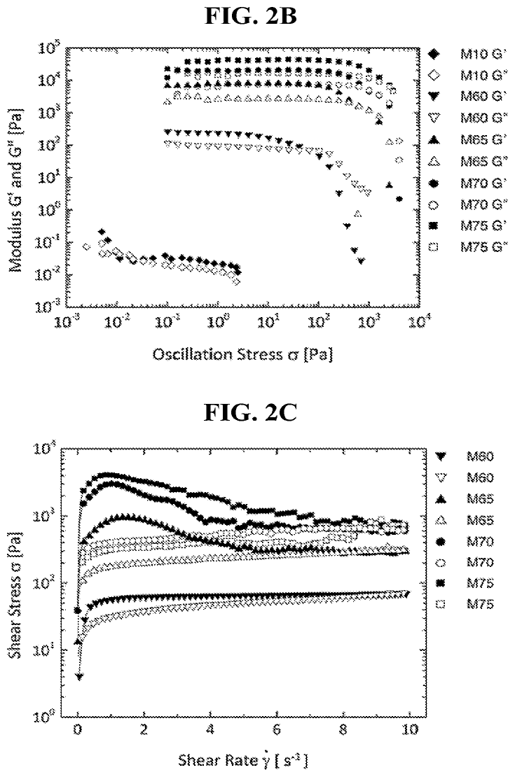

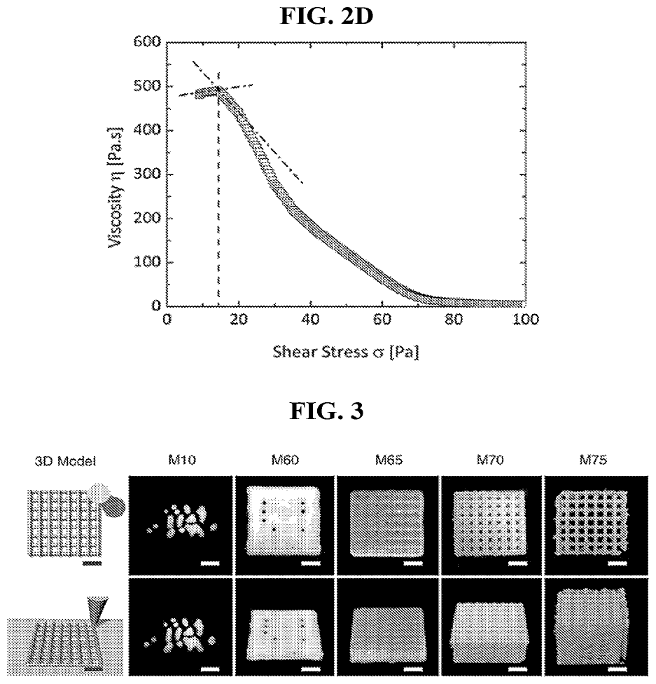

3D food printing is commonly demonstrated with the hot-melt extrusion that requires temperature-sensitive food material such as chocolate. However, in the present disclosure, milk was used as the example for demonstration via cold extrusion. An understanding of the rheology of materials helps determine the printability of the ink by cold extrusion. The present printable ink exhibits shear-thinning behavior, where the viscosity is low at a high shear rate to allow extrusion of ink from the nozzle. The rheological properties of the presently formulated inks were studied. The viscosity of present milk ink with different concentrations (10 to 75 w/w %, denoting 10 w/w % as M10, etc.) were plotted as a function of shear rate (see FIG. 2A and FIG. 6). The addition of milk powder increased the viscosity of the inks from 0.51±0.46 Pa·s (M10) to 46291.77±5626.42 Pa·s (M75). The viscosity of M60, M65, M70, and M75 decreased as the shear rate increased, suggesting that the formulated milk inks were shear-thinning and pseudoplastic fluids. The yield stress of the ink is a parameter in DIW 3D printing that is considered; it is the minimum shear stress to initiate flow; the flow of the ink suggested the loss of the cohesion among the colloidal particles due to van der Waals interactions. As the concentration of milk powder increased, the yield stress also increased from 0.01±0 Pa (M10) to 330.57±23.64 Pa (M75). The increase in yield stress implied that the colloidal network within the ink was enhanced as the concentration of milk powder increased. The mesh structures printed using inks of M10, M60, and M65 spread due to low yield stress (0.01±0 Pa for M10, 11.15±2.21 Pa for M60, 78.23±5.57 Pa for M65) (FIG. 3). The mesh structures printed using inks of M70 and M75 were maintained due to high yield stress (105.95±13.21 Pa for M70 and 330.57±23.64 Pa for M75) (FIG. 3). These observations suggested that a high value of yield stress allowed maintaining the printed structures of the materials. Nevertheless, the present ink composition remains printable via the present method.

To understand the degree of non-Newtonian characteristics, the Herschel-Bulkley model was applied to describe the rheological behavior of the formulated milk inks, which may be represented by the equations below.

σ=σ_{y}+K\dot{γ}ⁿ

log₁₀(σ−σ_{y})=log₁₀K+n log₁₀\dot{γ}

The shear-rate and shear-stress were subjected to curve fitting to Herschel-Buckley model to obtain flow behavior index (n) and flow consistency index (K) where n indicates the degree of non-Newtonian characteristics of the fluid and K indicates the degree of viscosity of the fluid. n<1 indicates that the fluid exhibits shear thinning behavior, and n>1 indicates that the fluid exhibits shear thickening behavior. n=1 indicates that the fluid is a Newtonian fluid. Yield stress (σ_{y}) was taken as the intersection point of the two tangent lines, one in the linear region of viscosity and the other where viscosity decreased drastically (FIG. 2D). The K and n were obtained by plotting log₁₀(σ−σ_{y}) against log₁₀\dot{γ} and fitting the best linear line; the y-intercept of the line was the value of n, and the gradient was the value of K. The values of n were all less than 1 (FIG. 6), indicating that all formulated milk inks exhibited shear-thinning behavior. The values of n of M10 were 0.86±0.12. This value was close to the value of 1, indicating that it had a low degree of shear-thinning behavior. The low yield stress of ink of M10 (0.01±0 Pa) caused leakage of ink from the nozzle. As the concentration of the milk powders increased, K also increased. The increase of K suggested increased mechanical strength of the ink at rest to hold the printed structures, which ensured the printability of the ink.

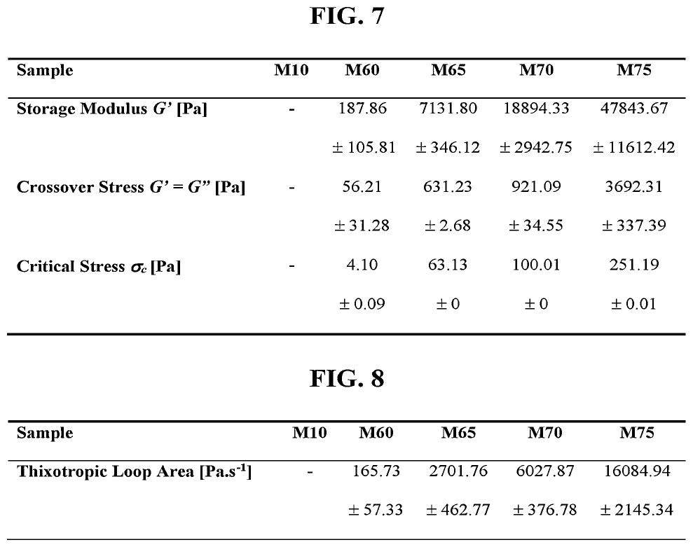

Oscillation amplitude tests were performed to determine the storage modulus (G′) and loss modulus (G″). These values helps in understanding of the viscoelastic property of the ink matrix. It was observed that G′ lay on the plateau in the linear viscoelastic region (LVR) (FIG. 2B). In this region, the colloidal network within the ink remained intact due to their elastic behavior. The G′ in this region is a measure of mechanical strength at rest, which is a parameter that determines the structural integrity of the printed material after deposition. As the concentration of milk powder increased, G′ increased from 187.86±105.81 Pa (M60) to 47843.67±11612.42 Pa (M75) (FIG. 7). The higher G′ suggested the stronger bonds and the higher printability of the ink. The values of G′ were higher than the values of G″ for all milk inks except M10. This observation indicated that the milk inks possessed solid-like behaviors, which allowed the printed material to retain its shape.

Finally, thixotropic loop tests were performed to understand the time-dependent breakdown and recovery of the microstructure of the milk inks. The inbound area between the ascending and descending curve of the thixotropy loop was measured as the scale of thixotropy (FIG. 2C). The addition of milk powder increased the thixotropy loop area from 165.73±57.33 Pa·s⁻¹ (M60) to 16084.94±2145.34 Pa·s⁻¹ (M75) (FIG. 8). It was observed that less spreading of printed mesh structures as the concentration of milk ink increased (FIG. 3). The reduced spreading of the ink suggested improved recovery of the colloidal network within the ink, which suggested that the degree of thixotropy increased with the increase in the concentration of the milk powder.

### Example 4B: Results/Discussion—Printability of Milk Ink

In DIW 3D printing herein, the present ink desirably has two characteristics: (1) exhibiting shear-thinning behavior and (2) maintaining its shape upon deposition. These are confirmed, as the values of n of the present ink were less than 1 to ensure shear-thinning characteristics (FIG. 6). At the same time, the present ink has high yield stress and storage modulus to help the printed material retain its shape and maintain structural integrity. In order to verify the printability of the inks, mesh structures were printed. The low yield stress of ink of M10 caused the ink to yield to the gravitational force, and the ink leaked from the nozzle without applied pressure. Thus, the ink of M10 appears less desirable to form defined layers and to create 3D models, but more suitable for printing undefined layers/structure. The mesh structures printed using inks of M10, M60, and M65 spread due to low yield stress (FIG. 3), rendering such inks suitable for printing undefined layers/structure. The mesh structures printed using inks of M70 and M75 were maintained due to high yield stress (FIG. 3). M70 was less viscous than M75; under similar printing conditions, M70 was extruded more smoothly than M75, which can be seen from discontinuous edges of the printed structures. While this example focused on characterizing rheological properties of different milk inks, other parameters such as (1) dispensing pressure, (2) nozzle velocity, and (3) nozzle diameter were also considered to determine the amount of the food inks extruded from the moving nozzle and achieve the print fidelity.

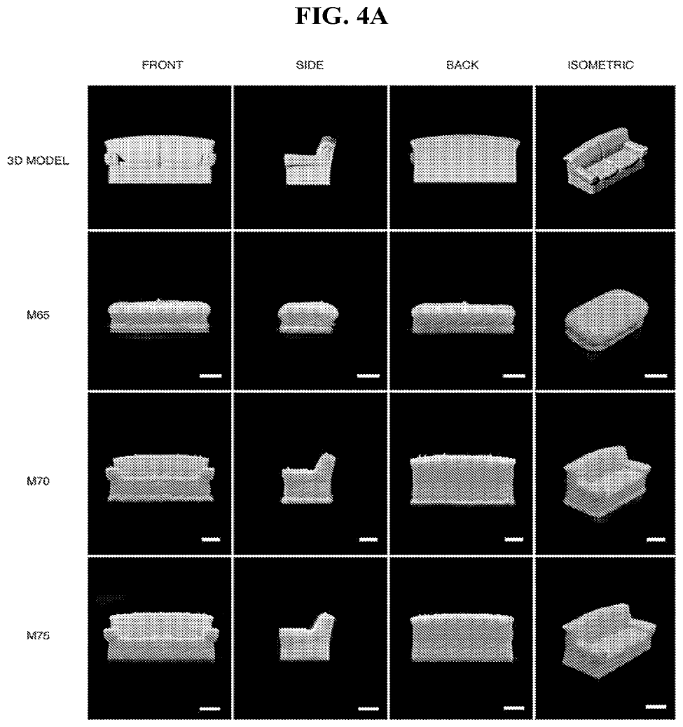

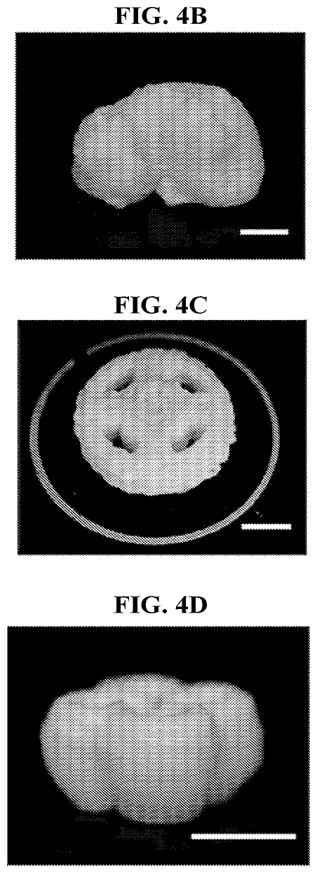

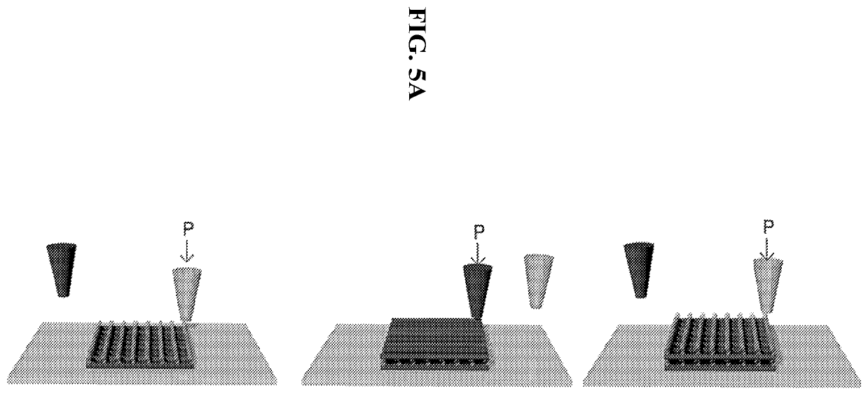

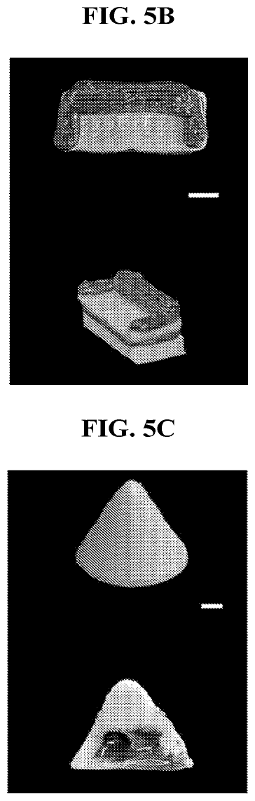

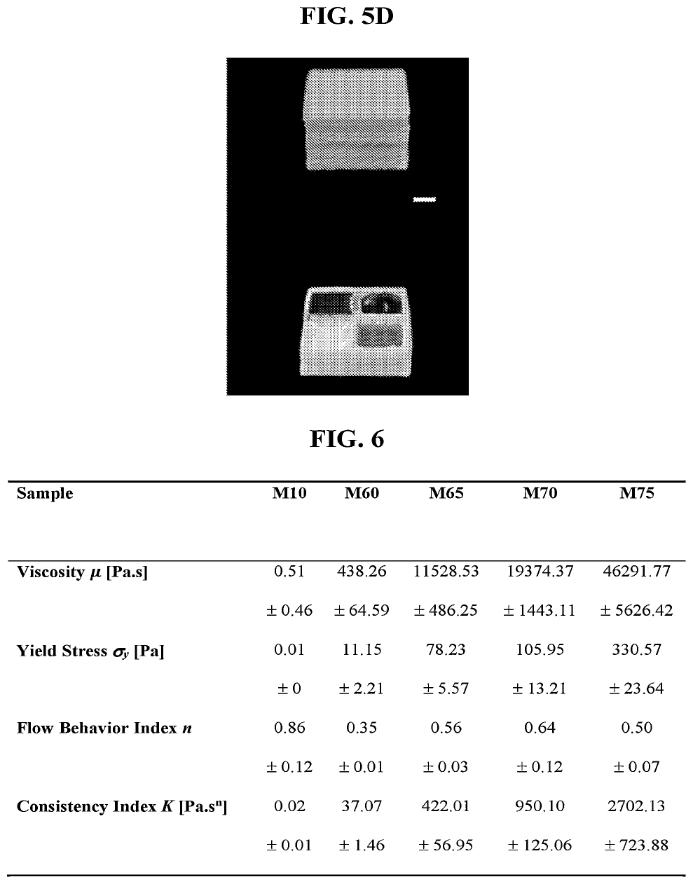

These observations suggested that M70 and M75 were more desirable candidates for 3D printing of complex structures (FIG. 4A to 4D). 3D model of a couch using inks of M65, M70, and M75 were fabricated (FIG. 4A), which is in contrast to FIG. 5B that demonstrates fabrication of a couch using different materials. The structure printed with ink M65 was not able to hold its shape due to low yield stress and storage modulus, but nevertheless suitable for 3D printing of undefined layers/structure. The structures printed with ink M70 and M75 were able to hold its shape due to high yield stress and storage modulus. Both inks were suitable to create 3D structures, while the yield stress and storage modulus of M70 were sufficient to allow the printed structure to hold its shape. Other geometries with the ink of M70 were printed, and the structures were able to support itself without deforming (FIG. 4B to 4D). Notably, M70 required less pressure than M75 for extrusion (because M70 was less viscous than M75), which is practically preferred when the operation of the instrument was limited to certain pressure. Overall, the use of milk powder without additional additive was demonstrated to formulate 3D-printable food inks via cold extrusion.

### Example 4C: Results/Discussion—Multi-Food Printing

In this example, multi-material printing using the DIW printer equipped with two independent syringes were demonstrated. A schematic illustration of the multi-food printing is shown (FIG. 5A). In multi-food printing, 3D models were printed using multiple syringes containing different food inks. Printing a 3D structure of a couch with milk ink and chocolate inks at different layers was demonstrated (FIG. 5B). The first few layers were printed with the milk ink, followed by a few layers with the chocolate ink. The subsequent layers were printed with the milk ink again. Alternatively, 3D printing of the structures containing different fillings was demonstrated (FIG. 5B to 5C). In this demonstration, the inks of chocolate, coconut, maple syrup, and blueberry were used as internal fillings. A 3D model with a rigid enclosure and soft fillings to provide different textures was produced. In this fabrication, the bottom layers of the 3D structures with voids were printed using milk ink. Next, the voids were filled with different inks using other syringes. Finally, the top layers were printed to close the voids. All inks used in this demonstration possessed different rheological properties. Those inks used as internal fillings were stably enclosed within the patterns created by M70, the rheology-modified milk ink. Overall, the present method of food 3D printing was feasibly extended to multi-food printing to create 3D models with materials possessing various rheological properties.

### Example 5: Summary, Commercial and Potential Applications

3D printing of milk-based materials using a DIW 3D printer is herein disclosed. 3D printable milk inks were formulated without additional rheological modifiers, and 3D structures were fabricated via cold extrusion using a DIW 3D printer at room temperature. Rheological characterizations to determine (1) viscosity, (2) yield stress, and (3) storage modulus of the inks were performed. Milk ink with 70 w/w % milk powder was suitable for DIW 3D printing with a yield stress of 105.95±13.21 Pa and a storage modulus of 18894.33±2942.75 Pa. The formulated ink was shear-thinning, with n<1 in Herschel-Buckley model, and capable of maintaining structural integrity upon deposition. Multi-material printing with milk ink and other edible inks were also demonstrated. The present method offers an improved route to formulate other edible inks without additives and fabricate a visually appealing meal without temperature control.

In summary, the present method developed is able to perform direct ink writing (DIW) three-dimensional (3D) printing of milk products at room temperature by changing the rheological properties of the printing ink. Advantageously, the present method can rely on only one milk product (i.e. powdered milk). The present method includes formulation of a powder milk that includes 70 w/w % milk ink, from which complex 3D structures are successfully fabricated as demonstrated in the present disclosure. The method can be operable for multi-material printing and creating food with various edible materials. Given the versatility of the present method, cold extrusion of food inks via the present method can be applied in creating nutritious and visually appealing food, with potential applications in formulating foods with various needs for nutrition and materials properties, where food inks could be extruded at room temperature without compromising the nutrients that may be degraded at elevated temperatures. Potential applications include formulating hospital foods required to be tailored for individual needs for the nutrition and texture, food manufacturing, food and beverage outlets, healthcare industries, etc.

While the present disclosure has been particularly shown and described with reference to specific embodiments, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

1. An edible and 3D printable milk-based ink composition comprising:
milk powder present in an amount ranging from 10 to 75 w/w %; and
water,
wherein the edible and 3D printable milk-based ink composition is both printable and remains in a single phase at a temperature ranging from 20° C. to 30° C.

2. The edible and 3D printable milk-based ink composition of claim 1, wherein the milk powder is present in an amount ranging from 65 to 75 w/w %.

3. The edible and 3D printable milk-based ink composition of claim 1, wherein the edible and 3D printable milk-based ink composition is a thixotropic fluid.

4. The edible and 3D printable milk-based ink composition of claim 1, wherein the edible and 3D printable milk-based ink composition has a flow consistency index ranging from more than 0.01 Pa sⁿ to 3450 Pa sⁿ, wherein n denotes a shear-thinning index ranging from more than 0 to less than 1.

5. The edible and 3D printable milk-based ink composition of claim 1, wherein the edible and 3D printable milk-based ink composition has a yield stress ranging from 0.01 Pa to 360 Pa.

6. The edible and 3D printable milk-based ink composition of claim 1, wherein the edible and 3D printable milk-based ink composition has a storage modulus ranging from 82 Pa to 60 kPa.

7. The edible and 3D printable milk-based ink composition of claim 1, further comprising an edible food ink, wherein the editable food ink comprises chocolate, coconut, maple syrup, blueberry, and/or milk cream.

8. The edible and 3D printable milk-based ink composition of claim 7, wherein the chocolate comprises:
a chocolate syrup, a chocolate paste, or a combination thereof; and
cocoa powder present in an amount ranging from 5 to 25 w/w %,

9. The edible and 3D printable milk-based ink composition of claim 1, wherein the edible and 3D printable milk-based ink composition is absent of additive, wherein the additive comprises xanthan gum or k-carrageenan gum.

10. A method of 3D printing an edible and 3D printable milk-based ink composition of claim 1, the method comprising:
providing the edible and 3D printable milk-based ink composition of claim 1; and
dispensing the edible and 3D printable milk-based ink composition onto a substrate in the absence of temperature control of the edible and 3D printable milk-based ink composition.

11. The method of claim 10, wherein providing the edible and 3D printable milk-based ink composition comprises filling one or more syringes with the edible and 3D printable milk-based ink composition, wherein each of the one or more syringes is configured with a nozzle.

12. The method of claim 10, wherein dispensing the edible and 3D printable milk-based ink composition comprises positioning the nozzle at a distance from the edible and 3D printable milk-based ink composition which has deposited on the substrate, wherein the distance ranges from 200 μm to 500 μm.

13. The method of claim 10, wherein dispensing the edible and 3D printable milk-based ink composition comprises dispensing the edible and 3D printable milk-based ink composition at a temperature ranging from 20° C. to 30° C.

14. The method of claim 10, wherein dispensing the edible and 3D printable milk-based ink composition comprises applying a pressure ranging from 100 to 550 kPa to dispense the edible and 3D printable milk-based ink composition.

15. The method of claim 10, further comprising:
providing an edible food ink, wherein the editable food ink comprises chocolate, coconut, maple syrup, blueberry, and/or milk cream; and
dispensing the edible food ink for 3D printing with the edible and 3D printable milk-based ink composition.
